(19) United States
(12) Patent Application Publication
(10) Pub. No.: US 2016/0069785 A1
(43) Pub. Date: Mar. 10, 2016

(54) Edge Sharpness Tester

(71) Applicant: Michael J. Brubacher, Scottsdale, AZ (US)

(72) Inventor: Michael J. Brubacher, Scottsdale, AZ (US)

(21) Appl. No.: 14/481,255

(22) Filed: Sep. 9, 2014

(51) Int. Cl. G01N 3/58; G01G 19/00

(52) U.S. Cl. CPC G01N 3/58; G01G 19/00

(57) ABSTRACT

An edge sharpness tester determines the level of sharpness of a cutting edge of a knife, razor blade, scalpel, or other tool having a sharp edge. A motive force is applied to a moveable element of the device. The movable element provides an interface with the edge of the sharp-edged device to severe a line mounted in the moveable element.

### BACKGROUND OF THE INVENTION

1. Field of the Invention

This invention is an edge sharpness tester. The device is used to determine the level of sharpness of the cutting edge of a knife, razor blade, scalpel, or other device having a sharp edge. In this device gravity alone is the key motive force in operation of the instrument. The motive force is applied in a linear fashion at vertical or very near vertical orientation to the edge of a sharp-edged device being tested.

2. Description of Known Art

Sharpness testing devices are well known in the art. Some mechanical devices use twisted fibers in the form of thread, twine or string as a test media while other devices use sheets of paper or silicon rubber as test media. Anecdotal and unsophisticated methods include drawing a sharp edge along a person's arm to see how effective the blade is in cutting hair from a person's arm. Another common technique is to draw a thumb perpendicularly across the sharpened blade. This is supposed to give some indication of the sharpness of the blade. All of these unsophisticated techniques are subjective.

An Internet search will return other anecdotal and non-quantifiable means of testing sharpness particularly as the sharpness tests refer to knife-edges. Slicing tomatoes and paper are among the most common. In fact these anecdotal tests tell us little about how sharp an edge actually is because even relatively dull edges can cut, slice or chop. The goal is to create a means whereby users can quantify the sharpness of any given edge for use.

Many designs of sharpness testers have been developed and patented. These include, among others, the following designs. U.S. Pat. No. 5,379,633 for a “Measurement of Cutting Edge Sharpness” discloses a device for measuring the sharpness of a meat-cutting blade. The device actually uses meat as the test media. U.S. Pat. No. 5,571,956 for “Apparatus and Method for Testing The Sharpness of Cutting Edges” uses a sheet of cutting medium as the target media to resist the cutting action of the blade being tested. This patent doesn't teach cutting a filament of material but rather cuts through a sheet of material. A recent publication is for a Testing Device and Method for Testing Scissors, Publication Number 2013/0186190 A1. This device cuts paper and couldn't easily be converted to a device similar in concept or function to the invention disclosed here. Many other testing techniques involve cutting through sheets of paper, silicone rubber and ordinary thread or string. The edge sharpness tester disclosed herein relies on the capability of repeatable data collection, in part, due to its use of monofilament fiber as the test media. Monofilament fiber is composed of a single, homogenous, synthetic fiber that is resistant to atmospheric effects. Monofilament fiber, usually in the form of monofilament line, is of consistent gauge and shear strength so is well suited as a test media yielding repeatable and accurate instrument measurements.

At the conclusion of a test event, most mechanical and electro/mechanical sharpness testing devices attempt to provide to the user some sort of quantifiable measurement information. Such quantifiable information might include the depth of cut or the number of sheets sliced through or amount of tension or pressure required to sever a line. Unlike this invention however, none of these previous inventions provide an easy means of comparison so that the quantified data provided has ready and instantaneous meaning for the user. For instance, the term “razor sharp” is a familiar term representing a relative value and, in fact, the term “razor sharp” is commonly used to describe a very sharp edge. The “razor sharp” term is based on familiarity with shaving razors, which are known to have a very sharp edge. For purposes of this sharpness testing device an unused shaving razor blade is used as a relative baseline measurement of “0,” or near “0,” meaning that the combined weight of the platen, the shaft supporting the platen and the clamping fixture or clevis also carried on the shaft, and, in some embodiments, the weight receiving container, is sufficient to sever the test line with little or no additional weight added. While the inventor recognizes that a shaving razor blade may not be the sharpest edge known it is, from a practical standpoint, a meaningful and practical datum point from which to reference an entire sharpness scale. The sharpness scale would be a relative scale useful in determining sharpness of sportsmen's knives, scissors, kitchen knives, military, industrial, commercial, and scientific cutting devices. Edges sharper than a razor blade edge have narrow practical use outside of some medical or scientific applications. If it is necessary to test these limited field edges a scale based on an edge sharper than a razor blade edge, but using the device presented here and the method of using the device would be tailored for the unique properties of medical and scientific applications.

The edge presented by a freshly flaked obsidian edge also provides a well-known sharp edge. An obsidian edge could also provide a baseline sharpness scale zero point.

Applicant believes that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicants will amend the specification to expressly recite the essential material that is incorporated by reference as allowed by the applicable rules.

### BRIEF SUMMARY OF THE INVENTION

The present invention provides, among other things, a testing device and testing protocol that is inexpensive, simple in structure and operation, effective, accurate and yields repeatable test results in a broad range of atmospheric conditions.

The purpose of the device is to test the sharpness of a blade edge or other sharp edge at a given particular point on the blade. The method of gauging the sharpness is via pressure, expressed as a given amount of weight, exerted on a fiber. Once the fiber is suspended at an angle, ideally, at or near a ninety-degree angle to the blade edge or sharp edge being tested and is in direct contact with the edge being tested, weight is added to the device so that downward pressure is simultaneously exerted on both ends of the fiber. When a sufficient amount of weight has been added into a weight-receiving container causing the fiber to press downwardly against the sharp surface of the edge being tested the fiber will eventually be severed. After the fiber is severed the added weight in the weight-receiving cup or container, including the weight of the cup or container, is measured (weighed) in ordered to quantify the amount of weight necessary to sever the line. In most cases a very light weight container, such as a plastic cup, may be used so as not to substantially affect the measurement result.

During any one testing event, the edge sharpness-testing device is designed to test the sharpness of a blade edge at a single point along the sharpened surface of a knife, scalpel, razor or the like. The method of how the device is used is also of unique interest. The method of gauging sharpness relies on measuring pressure, expressed as a given amount of weight, exerted on, in a preferred embodiment a fiber, such as but not limited to a monofilament fiber or alternatively, a fluorocarbon monofilament fiber of approximately 0.01-inch diameter. In other embodiments of the invention the inventor contemplates that the diameter of the fiber can be much greater or much less then the preferred diameter of 0.01 inch. The monofilament fiber will be of sufficient gauge to retain its integrity as it is being mounted in the device while being thin enough to be easily severed by a reasonably sharp edge without significant velocity of the clamping fixture descending on the fiber.

In a preferred embodiment of this device a fiber, in one embodiment a monofilament fiber, of known gauge is suspended at a ninety-degree angle, or other angle as desired by the operator of the device, to the edge of a knife blade that has been securely mounted in the test device. The angle at which the line crosses the edge is not believed to be a critical factor so long as the mechanical design of the fixture accommodates angles less than or greater than ninety degrees. The monofilament line is placed in direct contact with the sharp edge, weight is added to a fixture such that downward pressure exerted by the added weight is simultaneously exerted on both ends of the line. When a sufficient amount of weight has been added to a weight-receiving container or cup the monofilament line will be severed. The added weight is measured, by weighing on, for instance, a gram scale, in ordered to quantify the point where the monofilament fiber was severed. The device is activated such that a clamping fixture is lowered into contact with the taut filament. The clamping fixture will be urged lower so that the monofilament fiber is in direct contact with the edge of the blade.

Additional sharpening of the edge may be subsequently performed and the test-run again. The result of the second test shows how much improvement has been made in the sharpness of the edge.

One object of the invention is to make a sharpness tester that is a gravity-operated system.

Another object of the invention is a system that utilizes monofilament fiber as test media.

It is another object of the invention to provide a sharpness scale where a razor blade or edge approximately as sharp as a razor blade forms the sharpest end of the scale.

Another object of the invention is to provide an alternative sharpness scale where an obsidian edge forms the sharpest end of the scale.

An advantage of the invention is, in one embodiment, that the weighing or pressure measuring capability is built into the apparatus.

Another object of this invention is to provide a device that is accurate and produces repeatable data information.

It is also an object of the invention to provide a simple device that is easy to transport, easy to set up and easy to operate.

One advantage of the invention is that the blade holder is used to hold a blade in the sharpness tester and the same blade holder, still attached and holding the blade, can be used to hold the blade in a blade-sharpening device.

It is also an object of this invention to provide a blade holder that can be used to mount a blade in several different blade-handling devices.

Similarly, one advantage of the invention is that it does not require sophisticated hardware or electronics in order to produce repeatable results.

A further object of the invention is to provide a standard measurement protocol that can be used in a particular industry to provide a standardized scale of sharpness that can be used by everyone in a particular industry.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWING

A more complete understanding of the present invention may be derived by referring to the detailed description when considered in connection with the figures in which:

FIG. 1 is a side elevation view of the sharpness tester with a knife positioned in the blade holder of the device;

FIG. 2 is a view of the device of FIG. 1 with a weight container in position on the platen of the device;

FIG. 3 is a view of the weight container of the device on a measuring scale.

Elements depicted in the figures are illustrated for simplicity. They are presented to illustrate the invention to assist in an understanding thereof. The figures are not necessarily rendered according to any particular sequence, size, scale or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the invention is not limited to the examples that are described below.

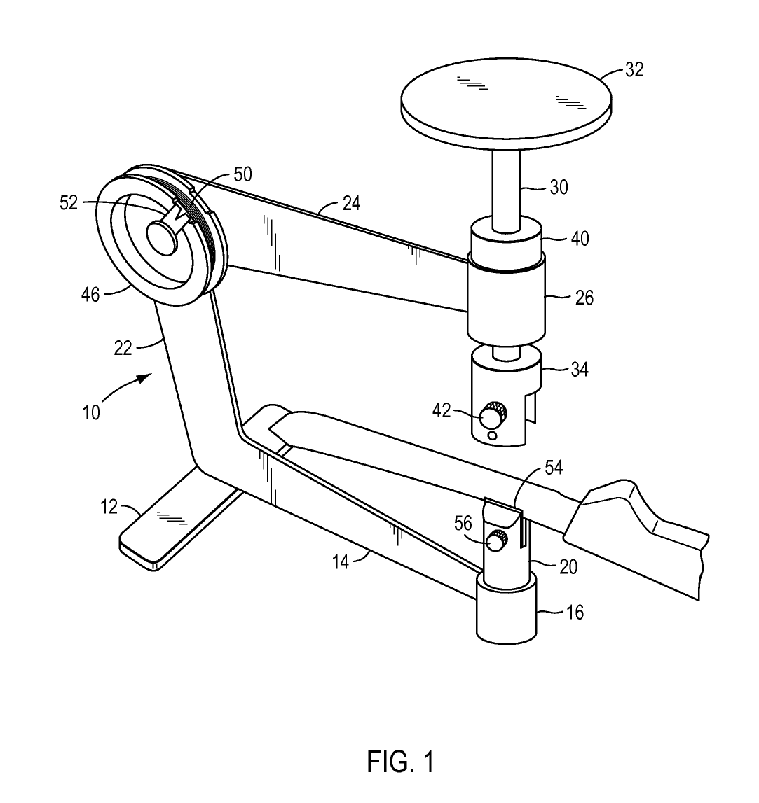

Turning to FIG. 1, there is a representation of the edge sharpness tester or edge sharpness testing device is shown as generally 10. The frame of the sharpness-testing device 10 includes a base support 12 to which an extending base leg 14 is attached. The outboard end of the extending base leg 14 has a foot 16. The foot 16 has a vertical bore into which a blade retention fixture or blade retention vise 20 is carried.

The blade-retaining fixture 20 may be a slot with a plastic tipped setscrew, 56, to pinch the knife into the slot. A more complicated vise-like apparatus is contemplated but it was found that the simple slot and setscrew design as shown is adequate in most situations. At the opposite end of the extending base leg 14 from the foot 16 and blade retention vise 20 there is an upstanding support 22 that supports a fixture arm 24. At the outboard end of the fixture arm 24 there is a housing 26 having a through bore. That through bore accommodates a shaft 30 that is a slip fit in the through bore. The shaft 30 is capable of moving vertically in the through bore.

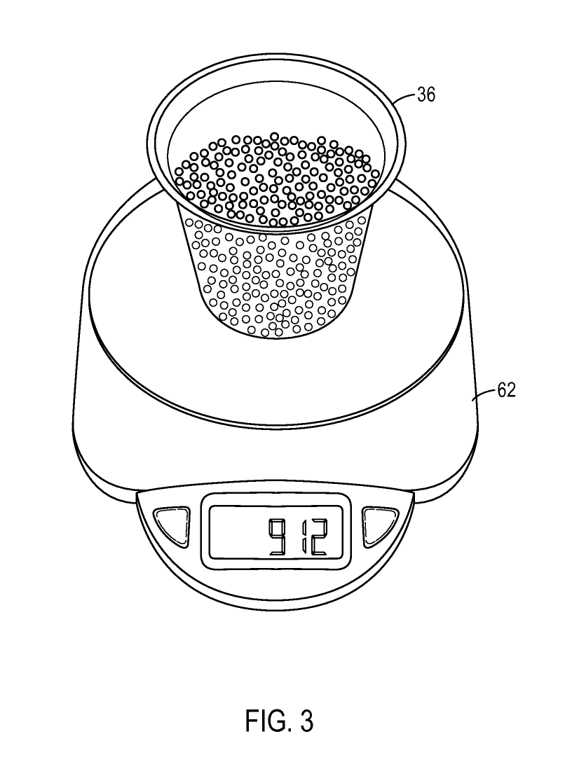

The upper end of the shaft 30 is attached to a platen 32. In one embodiment the platen is a flat round disc large enough to support a weight-receiving container 36 shown in FIG. 3.

A travel limiting stop, such as a pin, bolt, setscrew or similar device is used to limit the downward travel of the shaft 30.

In one embodiment a collar 40 is supported on the shaft 30 to function as a stop. The collar 40 has a through bore that is a close fit on the shaft 30. The collar 40 also has a threaded bore that accommodates a setscrew or alternatively, a thumbscrew, that when tightened will maintain the collar 40 in a restrained position on the shaft 30. The collar 40 limits the downward vertical travel of the platen 32, as would other travel limiting stops.

The shaft 30 extends to and is attached to a clamping fixture 34. One mode of attachment is to use a setscrew (not shown in the views used here but would be above the test media set screw on the “back” side of the clamping fixture) threaded through a bore in the side of the clamping fixture that will contact the shaft 30. The clamping fixture 34 is used to locate the test medium or test fiber, in most cases, a monofilament fiber, before and after the monofilament is severed by the sharp edge being tested. The position of the stop 40 mentioned above is adjusted to allow the clamping fixture 34 to travel downwardly to sever the test medium, i.e., the monofilament fiber, while preventing the clamping fixture 34 from travelling so far down that the clamping fixture 34 contacts the sharp edge of the knife or other sharp edge being tested in the device.

The clamping fixture 34 is generally a cylindrical body although in an alternative embodiment it may be a different shape such as, but not limited to, a square body shape. The clamping fixture 34 body is formed with a shaft-receiving bore in the top surface of the clamping fixture body. This bore will receive the shaft 30 in a secure and generally permanent fashion. The lower section of the clamping fixture is provided with a clamping fixture slot that extends from the bottom of the body for, as example, about two-thirds of the length of the clamping fixture body. The width of the slot may be about the same as the diameter as the shaft to which the clamping fixture is attached. The slot width is not critical as long as it is wide enough to accommodate a reasonable length of monofilament stretched across the slot and wide enough to accommodate the widest blade having a sharp edge to be tested. A blade being tested is seldom wider than one-quarter inch in width.

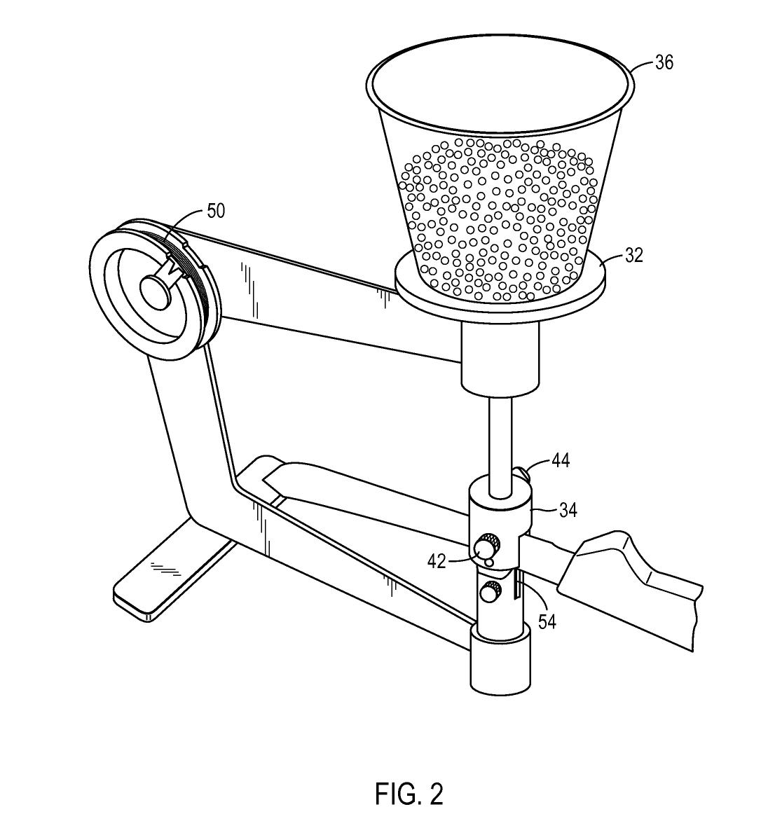

A pair of anchor points 42 and 44 (FIG. 2) also referred to as “pinching mechanisms” as they will pinch the test filament to hold it in place across the gap in the clamping fixture, are provided on the body of the clamping fixture. These anchor points 42 and 44, are used to anchor a length of monofilament or other test media, to the clamping fixture. Just below the anchor points are holes, or in an alternative embodiment, slots, that are used as guide elements to guide the test fiber from one anchor point 42, across the gap formed by the slot in the clamping fixture, and to the second anchor point. The anchor points 42 and 44 may be thumbscrews that clamp the test fiber securely. As mentioned above the anchor points may also comprise a “pinching” mechanism that is used to secure the line. This “pinching” or “clamping” of the fiber may be accomplished using a plurality of simple means and these drawings represent only one of those potential methods.

A spool 46 is mounted on a shaft attached to upstanding support 22. The spool 46 contains a supply of monofilament fiber 50, monofilament fiber being a preferred test media, or test fiber, that is used as the media that is cut by the blade mounted in the sharpness-testing device 10. The spool 46 may contain anywhere from a few inches to hundreds of feet of continuous line or, alternatively, pre-cut segments of monofilament fiber. The spool 46 may be mounted on the fixture as shown in these drawings or simply allowed to lay unattached on or near a work surface. In general, monofilament is any synthetic, man-made material produced or manufactured in the form of a filament, line, string, or fiber. Monofilament is also recognized as a single strand of untwisted synthetic fiber.

In one embodiment the spool 46 may be equipped with a cutting element used to sever lengths of monofilament line for mounting in the clamping fixture. In a preferred embodiment as shown, there is no cutting element. Cutting of the monofilament wouldn't be necessary. In one method of loading the clamping fixture with monofilament the monofilament is simply cut into pieces several inches long using a scissors or knife. The piece of monofilament is then inserted through the hole 60 in one side of the clamping fixture and pulled across the gap in the clamping fixture, through a slot in the other side of the clamping fixture, secured between a thumb screw and the body of the clamping fixture, and secured to the other side of the clamping fixture using the thumbscrew 42. The first hole 60 in the clamping fixture may be duplicated on the other side of the clamping fixture so that the monofilament passes through a hole on each side of the clamping fixture. In a preferred embodiment there is one hole and the aperture on the other side of the clamping fixture is a wedge-shaped cutout, wide at the bottom and tapering to a point at the top of the wedge. Two wedged shaped cutouts, one on each side of the clamping fixture, is also contemplated.

It is important that any potential sources of friction be reduced or eliminated from the testing apparatus and not be allowed to skew the test results significantly. The shaft 30 or plunger rod, moves vertically through a loose slip fit housing or guide 26 and exerts pressure inline on the clamping fixture 34 affording little possibility of friction or any other mechanical forces from affecting the measurement result.

The blade retention fixture 20 includes a blade-gripping element 54 or blade retention vise to hold the edge to be tested in a vertical position. In one embodiment the blade-gripping element 54 includes a t-handle 56 that has a threaded portion that will pass through one side of the gripping element and into a threaded portion of the gripping element. When a knife 60, having a sharpened edge, is positioned in the gripping element the knife is secured by tightening the t-handle to cause one side of the gripping element to move toward the other side the gripping element and thereby hold the knife securely in the gripping element.

The device is expected to be constructed of metal components however it is also possible that the device could be made of other material such as fiberglass, carbon fiber, plastic, wood, etc., or any combination thereof.

In FIG. 2 shows the weight-receiving container 36 in position on the platen 32. The container 36 has been partially filled with weight; in this case, round or spherically shaped weights such as, but not limited to, #9 lead shot, until the clamping fixture has moved down so that the monofiliment is severed by the sharp edge of the knife 60. In one embodiment of the invention the system of sharpness testing uses generally spherical weights as pressure producers. The inventor has experimented with many different forms and styles of weights utilized during the test process and found round shot, such as the shot found in shotgun shells, to be a superior media for weight manipulation. Round shot is readily available in sizes that weigh only a fraction of a gram and due to its geometric shape and low mass, flow smoothly and drop with little impact into the weight receiving container. The flow rate of round shot into the weight receiving container can also be regulated quite precisely either adding weight quite quickly or just a few pellets at a time. The size of the shot in a preferred embodiment is less than one inch in diameter. In most cases the shot size will be significantly less than one inch in diameter. In addition to shotgun shell shot the inventor contemplates the use of generally spherical fishing weights, ball bearings, or other generally spherical weights.

FIG. 3 shows the container 36, containing the amount of weight necessary to sever the monofilament as shown in FIG. 2, on a weight scale 62. The weight scale is used to determine the weight of the shot in the container 36. The weight scale utilized by the operator should be able to accurately determine weights expressed in grams or ounces and tenths of ounces or some other weight or pressure measurement scale of equivalent or superior resolution and precision.

After test results are studied further edge sharpening may be in order.

Additional sharpening of the edge may be subsequently performed and the test run again the results showing how much improvement has been made in the sharpness of the edge. The method of using the embodiment of the sharpness tester presented herein includes, at least, the acts of securing a knife or similar implement having a sharpened edge in the blade gripping element 54 with the sharp edge facing upward; position an empty weight receiving container, the tare weight of which has been measured previously; securing a length of monofilament fiber between one anchor point to the second anchor point of the clamping fixture. The monofilament fiber or test fiber 50 will be stretched across the clamping fixture gap in the clamping fixture 34. A technician will restrain the clamping fixture from descending until she is ready to perform the test of severing of the monofilament. When ready to proceed the technician will gently let the monofilament rest on top of the knife-edge without severing the edge. The technician will add small increments of weight to the weight-receiving container until the monofilament is severed. At this point the technician will weigh the weight-receiving container on the gram scale 62. The resulting value, either with or without consideration of the tare weight of the weight-receiving container depending on test protocol, will be noted. As mentioned above, the test blade can then be resharpened if desired to determine the improvement in sharpness of the tested blade.

In general using the tester is designed to test the sharpness of a single given point or location of the edge of the blade, before, during or after sharpening. If the blade edge has been either worn by use prior to sharpening or is sharpened in a homogeneous and uniform manner, a single point of testing will be sufficient to give the technician a general idea of the sharpness of the entire length of the sharpened surface. The technician may decide, however, either as a result of need to test other points on the blade or because of special circumstances, to test the blade sharpness at multiple points along the blade in order to accumulate more detailed sharpness data.

A user can document the progress made during any individual sharpening event and then share that quantified information with a friend or associate. Scaled sharpness data would have meaning for anyone familiar with the sharpness tester presented here and it's use. For instance a user of the device would realize that a test value of a blade edge with a value of a thousand grams is quite dull and a value of sixty grams is approaching the sharpness of a shaving razor blade. The sharpness of a razor blade has been selected by the inventor as the base line or zero sharpness indicia.

Several variations of common and inexpensive test lines or filimaments were analyzed, explored and tested. Samples of cotton and other fabric thread yielded non-repeatable results. Generally, thread is a possible alternative media, but has been found to not be as good as monofilament or fluorocarbon infused monofilament fiber. Thus thread is not a preferred test media. It is also contemplated by the inventor that the sharpness testing system may be a system where a monofilament fiber is utilized as test media and the filament fiber may consist of some percentage of the filament fiber being fluorocarbon.

Monofilament fibers are viable test media. Nylon monofilament fiber returned consistent test results. Fluorocarbon coated monofilament lines are an improvement over standard nylon monofilament fibers. Continuously infused or impregnated fluorocarbon lines perform the best, and are a second preferred test media, with respect to test repeatability and breadth of scale. The most consistent results of sharpness testing are obtained using continuously infused or impregnated fluorocarbon monofilament line as the test fiber or test media.

In another embodiment a human powered edge sharpness testing apparatus is provided that doesn't rely on the use of adding weight to a weight container until the test media is severed. In this embodiment of the device a human technician will physically cause downward pressure to be applied to the shaft and clamping fixture assembly and the peak amount of pressure applied measured and/or logged electronically by a measuring device, such as, but not limited to an electronic scale. The amount or quantity of downward pressure applied as read by the scale will be an indicator of the sharpness of the edge.

The inventor has also contemplated variations and alternatives to the invention configuration described above. In one preferred embodiment the system is configured where the fiber is lowered onto an edge as described above.

In another embodiment the system is configured where the edge is lowered onto a constrained fiber. This would be an embodiment where the apparatus is inverted so that the knife holder and the knife is mounted above the test media holder and will fall onto the test media below it as weight is added to the weight container above the knife. In this embodiment the knife is lowered into the clamping fixture holding the test media. In essence, the clamping fixture is 34 is changed in position with the blade retention vise 20. The clamping fixture opening is now facing upward and the knife blade is facing downward, opposite of what is shown in FIG. 1. In other respects the apparatus and method of using the apparatus will be the same as described above.

Another alternative embodiment is to mount the entire test device on a scale. This will eliminate the step of removing the weight container after a test media is severed and putting it on a separate scale for weighing. With the device on a scale the instant the test media is severed the scale can be read directly.

The inventor contemplates that the blade holder or blade retention vise can be used to hold a blade in several different blade-processing devices. For instance, a blade can be initially mounted into a blade retention device. The device will grip the blade on the unsharpened edge of the blade usually about midway from the point of the blade to the tang of the blade. The device will comprise, but not limited to a vise portion carried on a ⅝-inch diameter shaft. This shaft will fit into a receiving hole in the device that is being used to process the knife blade. With this blade retention vise the blade can first be mounted, for instance, in a blade sharpening apparatus. After sharpening the blade, the blade, with the blade retention vise still attached, can be moved to a sharpness testing apparatus and the blade retention vise inserted into a hole in the sharpness testing apparatus. This process can be repeated as necessary until a technician is satisfied that the blade is processed, as he desires. The object of this aspect of the invention is to eliminate the need for un-mounting a blade and remounting a blade as the blade is moved from one operation to another.

In summary, the invention is a blade sharpness testing apparatus for testing the sharpness of a single point on a blade by severing a test filament. The device comprises at least a frame having an extending base leg and a foot portion at one end of the base leg. It includes a blade retention fixture or blade retention vise carried by the foot of the base leg and the blade retention fixture or vise includes a blade-gripping element. There is an upstanding support extending upwardly from the base leg of the frame and a fixture arm extending from the upstanding support. This fixture arm supports a housing at the outboard end of the fixture arm while the housing also comprises a through bore. There is a shaft carried in the through bore of the housing at the end of the fixture arm. This shaft has a diameter close to the diameter of the through bore to enable a sliding fit between the shaft and the through bore. A travel-limiting stop is carried on the shaft above the housing location at the end of the fixture arm. A platen is carried at an upper end of the shaft above the end of the fixture, the platen having a planar surface perpendicular to the major axis of the shaft. There is a clamping fixture with a gap in the end of the clamping fixture. This clamping fixture is carried at a lower end of the shaft below the housing at the end of the fixture, and the clamping fixture further comprises a pair of anchor points to secure the test media or test filament in the clamping fixture with the test filament bridging the gap in the end of the clamping fixture. Lastly, there is a weight-receiving cup carried on the platen whereby weight in the weight-receiving cup will displace the clamping fixture downwardly through the through bore of the housing at the end of the fixture arm.

Another way to summarize the invention is to say that the device comprises gravity powered edge sharpness testing apparatus for testing the sharpness at any given location along an edge of a sharp-edged device by severing test media. The apparatus comprises a vertical framework containing an upper portion housing a free moving, vertically orientated shaft. This shaft had a lower end comprising a clamping fixture with the clamping fixture having a first and a second anchor point and an open span between the anchor points. A section of test media, having a first and a second end, is secured at each end independently to the first and to the second anchor points across the open span of the clamping fixture. The vertical framework also contains an edge retaining lower portion, which is aligned vertically and horizontally with the upper portion of the vertical framework. In operation the shaft and clamping fixture, with attached test media, is lowered until the test media rests in contact with the cutting edge. The test media will span the cutting edge. Downward pressure is subsequently and increasingly applied to the upper end of the shaft until the test media is severed by the restrained cutting edge.

1.) In the version of the blade retention vise with a post that can be inserted into compatible holes in several devices related to the handling of a knife blade the method can be summarized as follows. The blade retention vice is includes a method of facilitating the movement of a knife blade from a first device, in this situation the first device can be a blade sharpening device, to a second device. The first device will have a hole in the device. The second device, which could the sharpness testing device extensively disclosed in this specification, also includes a hole in the second device. A technician will mount the knife blade in a blade retention vise. This device, the blade retention vise, will include a vertical post supporting the vise portion of the blade retention vise. The technician will insert the vertical post of the blade retention vise into the hole of the first device to hold the knife blade in the first device so that an operation on the blade is performed. The technician will remove the blade retention device from the hole in the first device when processing at the device is completed. He will then, if needed or desired, insert the vertical post of the blade retention vise into the hole of the second device to hold the knife blade in the second device. A second operation on the knife blade is carried out. With the blade retention vise attached to the knife blade and not to the device used for performing an operation, the knife blade can be quickly and easily transferred and mounted to a second, third or subsequent device to perform operations on the knife blade.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claim.

What is claimed is:

1. A sharpness testing apparatus for testing the sharpness of an edge of a blade comprising:
a frame;
a blade retention vise attachable to the frame;
a fixture arm carried on the frame, the fixture arm supporting a housing having a through bore;
a shaft carried in the through bore of the housing;
a clamping fixture carried at a lower end of the shaft below the housing the clamping fixture further comprising an anchor point.

2. The apparatus in accordance with claim 1 further comprising a travel-limiting stop carried on the shaft above the housing location at the end of the fixture arm.

3. The apparatus in accordance with claim 1 further comprising a platen carried at an upper end of the shaft above the end of the fixture arm.

4. The apparatus in accordance with claim 3 further comprising a weight-receiving cup carried on the platen whereby weight in the weight-receiving cup will displace the clamping fixture through the through bore of the housing.

5. The apparatus in according with claim 1 further comprising a test fiber.

6. The apparatus in accordance with claim 5 wherein the test fiber comprises a monofilament fiber as the test fiber.

7. The apparatus in accordance with claim 6 wherein the test fiber comprises fiber having a percentage of the fiber being a fluorocarbon fiber.

8. A sharpness testing apparatus for testing the sharpness of a particular point on the edge of a blade comprising:
a frame having an extending base leg and a foot portion at one end of the base leg;
a blade retention fixture carried by the foot of the base leg, the blade retention fixture including a blade-gripping element;
an upstanding support extending upwardly from the base leg of the frame;
a fixture arm extending from the upstanding support, the fixture arm supporting a housing at the outboard end of the fixture arm, the housing having a through bore;
a shaft carried in the through bore of the housing at the end of the fixture arm, the shaft having a diameter close to the diameter of the through bore to enable a sliding fit between the shaft and the through bore;
a travel-limiting stop carried on the shaft above the housing location at the end of the fixture arm;
a platen carried at an upper end of the shaft above the end of the fixture;
a clamping fixture having a gap in the end of the upper clamping fixture, the clamping fixture carried at a lower end of the shaft below the housing at the end of the fixture, the clamping fixture further comprising a pair of anchor points;
a weight-receiving cup carried on the platen whereby weight in the weight-receiving cup will displace the clamping fixture downwardly through the through bore of the housing at the end of the fixture arm.

9. The apparatus in accordance with claim 8 wherein the sharpness testing apparatus is gravity operated.

10. The apparatus in accordance with claim 8 further comprising test fiber.

11. The apparatus in accordance with claim 10 wherein the test fiber comprises a monofilament fiber as the test fiber.

12. The apparatus in accordance with claim 11 wherein the test fiber comprises the fiber having a percentage of the fiber being a fluorocarbon fiber.

13. The apparatus in accordance with claim 8 wherein the weight in the weight-receiving cup comprises generally spherical weights having a diameter of less than one inch.

14. The invention in accordance with claim 8 further comprising a weighing scale integral with the frame whereby the scale to measure the weight necessary to sever the fiber is built into the apparatus.

15. A method of processing a knife blade in a first device and in a second device comprising using the first device for measuring the sharpness of an edge comprising the acts of:
positioning a blade in a blade retention vise, the blade retention vise comprising a vertical post supporting the vise portion of the blade retention vise;
positioning a clamping fixture, the clamping fixture having a gap therein, apart from and above the blade holder;
restraining a test fiber in the clamping fixture such that the test fiber bridges the gap in the clamping fixture;
lowering the clamping fixture until the blade contacts the test fiber;
releasing the clamping fixture and adding sufficient weight to the clamping fixture to drive the clamping fixture through the test fiber;
recording the amount of weight needed to sever the test media.

16. The method in accordance with claim 15 further comprises the act of referencing the recorded amount of weight to a sharpness scale measured as a standard measure of weight.

17. The method in accordance with claim 16 wherein the sharpness scale comprises a sharpness index number of near zero comparable to the sharpness of a freshly flaked obsidian edge.

18. The invention in accordance with claim 16 wherein the sharpness scale ranges from a sharpness index number of near zero comparable to the sharpness of an unused razor blade.

19. The method in accordance with claim 15 further comprising facilitating the movement of the knife blade from the first device, the first device having a hole in the device, to a second device, the second device also including a hole in the device, the method comprising the acts of:
inserting the vertical post of the blade retention vise into the hole of the first device to hold the knife blade in the first device.

20. The method in accordance with claim 19 further comprising the acts of removing the blade retention device from the hole in the first device; and
inserting the vertical post of the blade retention vise into the hole of the second device to hold the knife blade in the second device.

21. An edge sharpness testing device including a test media clamping fixture for anchoring test media in the edge sharpness testing device, the edge sharpness testing device comprising an electronic scale to measure and log the peak amount of pressure required for an edge being tested to sever the test media.
